(19) United States
(12) Patent Application Publication
(10) Pub. No.: US 2025/0356612 A1
(43) Pub. Date: Nov. 20, 2025

(54) Gating UI Invocation Based on Object or Self Occlusion

(71) Applicant: Apple Inc., Cupertino, CA (US)

(72) Inventors: Chase B. Lortie, San Francisco, CA (US); Daniel J. Brewer, Redwood City, CA (US)

(21) Appl. No.: 19/191,986

(22) Filed: Apr. 28, 2025

Related U.S. Application Data
(60) Provisional application No. 63/649,051, filed on May 17, 2024.

(51) Int. Cl. G06V 10/26; G06F 3/01; G06V 40/10; G06V 40/20

(52) U.S. Cl. CPC G06V 10/26; G06F 3/017; G06V 40/11; G06V 40/28

(57) ABSTRACT

Enabling gesture recognition and input based on hand tracking data and occlusion information is described. A determination is made as to whether a hand or a portion of a hand is occluded by a physical object or by the hand itself, and filters and consolidate the occlusion scores for each portion of the hand to determine whether to invoke or dismiss an input action associated with an input gesture. In doing so, hand tracking data can be used to obtain occlusion data and pose data from which input gesture invocation and gating can be implemented.

### BACKGROUND

In the realm of extended reality (XR), hand gestures are becoming an increasingly intuitive method for user input, offering a seamless way to interact with virtual environments. Hand tracking technologies allow users to perform a variety of gestures that the system can recognize and interpret as commands. For instance, a pinch could be used to select an object, while a swipe motion might navigate through menus or rotate a 3D model. Some systems allow for more complex gestures, like using sign language to input text or control actions within the virtual space. This hands-free approach not only enhances the immersive experience but also provides a natural and ergonomic way to interact, reducing the reliance on physical controllers. As XR technologies evolve, the potential for hand gesture input is expanding, promising more sophisticated and responsive interfaces that cater to a wide range of applications and user preferences. However, what is needed is an improved technique to improve the detection of an input gesture from a hand pose, and detect unintentional hand gestures.

### BRIEF DESCRIPTION OF THE DRAWINGS

FIGS. 1A-1B show example diagrams of a user using a hand pose as an input pose, in accordance with one or more embodiments.

FIG. 2 shows a flowchart of a technique for processing input gesture actions, in accordance with some embodiments.

FIG. 3A, 3B, and 3C shows diagrams of hand tracking information, in accordance with one or more embodiments.

FIG. 4 shows a flowchart of a technique for determining an occlusion score, in accordance with some embodiments.

FIG. 5 shows a flowchart of a technique for determining whether a joint is self-occluded, in accordance with one or more embodiments.

FIG. 6 shows a flowchart of a technique for processing input gesture actions, in accordance with one or more embodiments.

FIG. 7 shows an example state machine for determining a gesture detection state, in accordance with one or more embodiments.

FIG. 8 depicts a flowchart of a technique for determining object occluded state, in accordance with one or more embodiments.

FIG. 9 depicts a flowchart of a technique for classifying reliability of self occlusion state, in accordance with one or more embodiments.

FIG. 10 depicts a flow diagram for determining an object detection state, in accordance with one or more embodiments.

FIG. 11 depicts an example state machine for invoking input gesture actions, in accordance with one or more embodiments.

FIG. 12 shows a system diagram of an electronic device which can be used for gesture input, in accordance with one or more embodiments.

FIG. 13 shows an exemplary system for use in various extended reality technologies.

### DETAILED DESCRIPTION

This disclosure pertains to systems, methods, and computer readable media to enable gesture recognition and input. In some enhanced reality contexts, image data and/or other sensor data can be used to detect gestures by tracking hand data. For example, hand joints may be tracked to determine whether a hand is performing a pose associated with an input gesture. However, when a hand is holding an object, the position of the joints may appear to be performing an input gesture. Thus, techniques described herein prevent the accidental activation of an input action associated with an input gesture when the user's hand is holding an object.

Techniques described herein are used to distinguish between whether a hand or portion of a hand is occluded by a physical object (for example, a physical object being held by the hand), or if the hand is self-occluded. A hand may be self-occluded, for example, if the fingers are in a curled position such that the fingers are blocking a view of a portion of the hand. In some embodiments, hand tracking techniques provide hand tracking data based on characteristics of different portions of the hands, such as joints in the hand. In some embodiments, each joint may be associated with location information and an occlusion score which may indicate whether a portion of the hand associated with the particular joint is visible from the camera or other sensors capturing the hand tracking data.

According to one or more embodiments, the occlusion scores for the various portions of the hand can be combined with a hand pose geometry to determine whether each portion of the hand is self-occluded or occluded by another object. The occlusion values for each portion of the hand may be filtered depending upon whether the portion of the hand is determined to be self-occluded or occluded by another object according to the hand pose geometry. The inclusion values for each portion of the hand may be consolidated into a single value that corresponds to a confidence value that the occlusion is caused by a physical object. The consolidated value can then be used to suppress or dismiss input actions arising from the hand pose, such as presentation of virtual content such as user interface (UI) components, input actions, or the like.

Embodiments described herein provide an efficient manner for determining whether a user is performing an input gesture using hand tracking data by reducing accidental input gestures caused by a hand being occupied or otherwise occluded by a physical object. Further, embodiments described herein improve upon input gesture detection techniques by considering the pose of the hand along with occlusion scores to further infer whether a detected gesture is intentional, thereby improving usefulness of gesture-based input systems.

In the following disclosure, a physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an XR environment refers to a wholly or partially simulated environment that people sense and/or interact with via an electronic device. For example, the XR environment may include Augmented Reality (AR) content, Mixed Reality (MR) content, Virtual Reality (VR) content, and/or the like. With an XR system, a subset of a person's physical motions, or representations are tracked, and in response, one or more characteristics of one or more virtual objects simulated in the XR environment, are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include: head-mountable systems, projection-based systems, heads-up displays (HUD), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mountable system may have one or more speaker(s) and an integrated opaque display. Alternatively, a head-mountable system may be configured to accept an external opaque display (e.g., a smartphone). The head-mountable system may incorporate one or more imaging sensors to capture images or video of the physical environment, and/or one or more microphones to capture audio of the physical environment. Rather than an opaque display, a head-mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed concepts. In the interest of clarity, not all features of an actual implementation may be described. Further, as part of this description, some of this disclosure's drawings may be provided in the form of flowcharts. The boxes in any particular flowchart may be presented in a particular order. It should be understood, however, that the particular sequence of any given flowchart is used only to exemplify one embodiment. In other embodiments, any of the various elements depicted in the flowchart may be deleted, or the illustrated sequence of operations may be performed in a different order, or even concurrently. In addition, other embodiments may include additional steps not depicted as part of the flowchart. Moreover, the language used in this disclosure has been principally selected for readability and instructional purposes and may not have been selected to delineate or circumscribe the inventive subject matter, or resort to the claims being necessary to determine such inventive subject matter. Reference in this disclosure to “one embodiment” or to “an embodiment” means that a particular feature, structure, or characteristic described in connection with the embodiment is included in at least one embodiment of the disclosed subject matter, and multiple references to “one embodiment” or “an embodiment” should not be understood as necessarily all referring to the same embodiment.

It will be appreciated that in the development of any actual implementation (as in any software and/or hardware development project), numerous decisions must be made to achieve a developer's specific goals (e.g., compliance with system-and business-related constraints) and that these goals may vary from one implementation to another. It will also be appreciated that such development efforts might be complex and time-consuming but would nevertheless be a routine undertaking for those of ordinary skill in the design and implementation of graphics modeling systems having the benefit of this disclosure.

For purposes of this application, the term “hand pose” refers to a position and/or orientation of a hand.

For purposes of this application, the term “input gesture” refers to a hand pose or motion which, when detected, triggers a user input action.

### Example Hand Poses

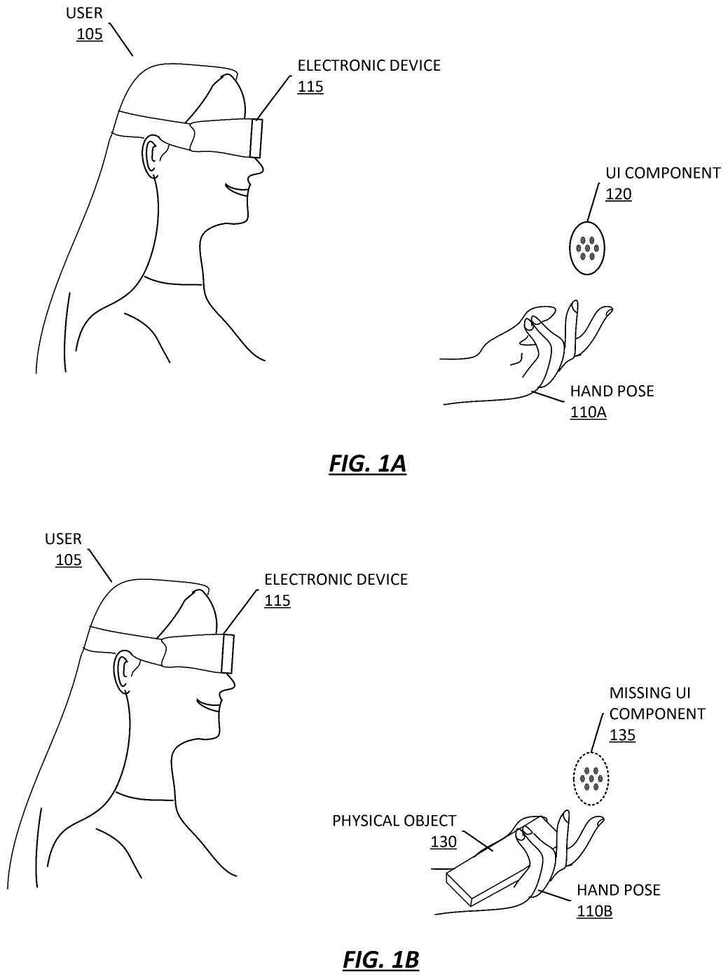

FIGS. 1A-1B show example diagrams of a user performing a first input gesture, in accordance with one or more embodiments. In particular, FIG. 1A shows a user 105 using an electronic device 115 within a physical environment. According to some embodiments, electronic device 115 may be a head mounted device such as goggles or glasses, and may optionally include a pass-through or see-through display such that components of the physical environment are visible. In some embodiments, electronic device 115 may include one or more sensors configured to track the user to determine whether a pose of the user should be processed as user input. For example, electronic device 115 may include outward-facing sensors such as cameras, depth sensors, and the like, which may capture one or more portions of the user, such as hands, arms, shoulders, and the like. Further, in some embodiments, the electronic device 115 may include inward-facing sensors, such as eye tracking cameras, which may be used in conjunction with the outward-facing sensors to determine whether a user input gesture is performed.

Certain hand positions or gestures may be associated with user input actions. In the example shown, user 105 has their hand in hand pose 110A, in a palm-up position. In some embodiments, the hand pose 110A may be determined to be a palm-up input pose based on a geometry of tracked portions of the hand, such as joints in the hand. For example, the geometric characteristics of the arrangement of joints in the hand can be analyzed to determine whether the hand is performing a user input gesture.

For purposes of the example, the palm-up position may be associated with a user input action to cause user interface (UI) component 120 to be presented. According to one or more embodiments, UI component 120 may be virtual content which is not actually present in the physical environment, but is presented by electronic device 115 is an extended reality context such that UI component 120 appears within physical environment from the perspective of user 105. Virtual content may include, for example, graphical content, image data, or other content for presentation to a user.

Because hand tracking relies on the position and geometric characteristics of the different portions of the hand, input gestures may be detected when they are performed unintentionally, such as when a person performs a hand pose in the context of interacting with an object. As shown in FIG. 1B, the user 105 is performing the same hand pose 110B. However, hand pose 110B shows a hand holding a physical object 130. Thus, an analysis of the geometry of tracked portions of the hand, such as joints in the hand, may lead to a determination that the hand pose 110B corresponds to a palm-up input gesture, as was determined by hand pose 110A of FIG. 1A. However, because the hand pose 110B of FIG. 1B is performed while the user is holding the physical object 130, the input gesture is likely unintentional. Thus, the invocation of the UI component associated with the gesture will be blocked, as shown by missing UI component 135.

Notably, hand pose 110A of FIG. 1A and hand pose 110B of FIG. 1B both show ring and pinky fingers curled over the hand so as to obstruct the palm from the perspective of the electronic device 115. However, hand pose 110A shows the ring finger and pinky finger curled as part of the natural pose of the palm-up position, whereas hand pose 110B of FIG. 1B shows the pinky and ring fingers curled because they are holding physical object 130. Accordingly, techniques described herein provide the capability of differentiating between occlusions caused by the hand pose causing portions of the hand to be self-occluded, and occlusion caused by the presence of physical objects in or near the hand. By differentiating between the type of occlusion, UI invocation or other user input actions may be gated when the hand is occupied, thereby reducing the likelihood of unintentional input actions being invoked by a hand pose.

### Gesture Invocation and Gating Overview

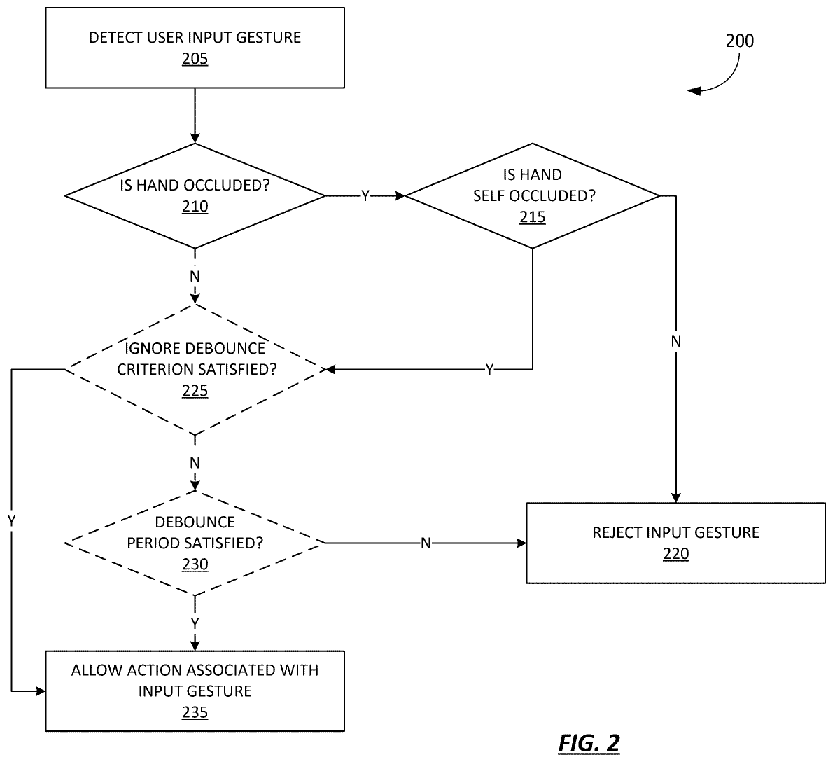

Techniques described herein are generally directed to gating input actions from input gestures having some occlusion based on a determination as to whether the occlusion is caused by a physical object, or whether the hand is self-occluded. FIG. 2 shows a flowchart of a technique for processing input gesture actions, in accordance with some embodiments. For purposes of explanation, the following steps will be described as being performed by particular components. However, it should be understood that the various actions may be performed by alternate components. The various actions may be performed in a different order. Further, some actions may be performed simultaneously, and some may not be required, or others may be added.

The flowchart 200 begins at block 205, where a user input gesture is detected. A user input gesture may be determined in a variety of ways. For example, hand tracking data may be obtained from one or more camera frames or other frames of sensor data. The hand tracking data may be used to determine a hand pose. The hand pose may be based on a geometry of the tracked portions of the hand, for example, from the hand tracking data. In some embodiments, the input gesture may be detected based on the hand pose, and/or based on additional data, such as gaze information, device information, application state of one or more applications running on the device, user interface configuration, or the like.

The flowchart 200 proceeds to block 210, where a determination is made as to whether the hand is occluded. In some embodiments, hand tracking data may include one or more occlusion scores from which a determination may be made that the hand is occluded. As another example, image data may be used to determine whether a portion of the hand is occluded, for example, using computer vision techniques or the like.

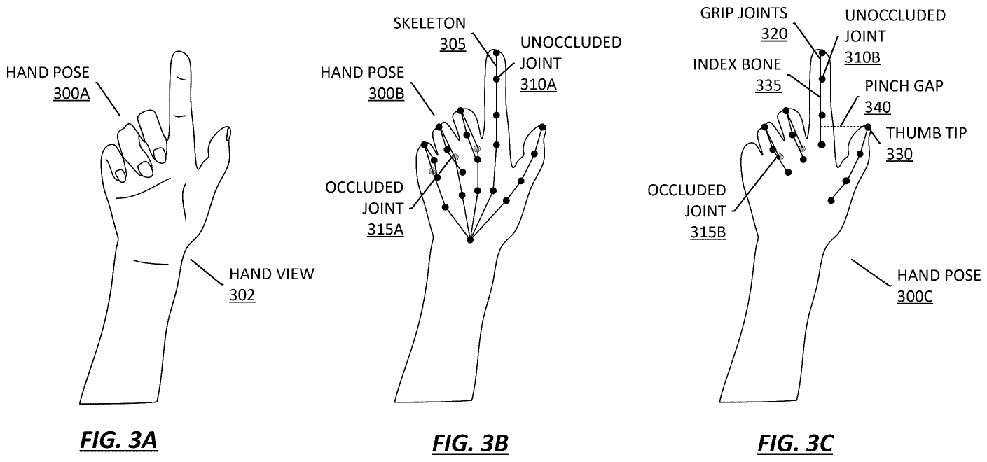

If the determination is made at block 210 that the hand is occluded, then the flowchart 200 proceeds to block 215, and determination is made as to whether the hand is self-occluded. The determination as to whether the hand is self-occluded may be part of determining whether the hand is occluded at block 210, or may be a separate determination. For example, the determination as to whether the hand is self-occluded may be based on image data capturing a view of the hand from the perspective of the camera of a head mounted device. As another example, whether the hand is occluded by itself or by a physical object may be based on geometric characteristics of different portions of the hand provided by the hand tracking data. The determination as to whether the hand is self-occluded may be performed in a variety of ways, as will be explained in greater detail below with respect to FIGS. 3-5. According to one or more embodiments, if the hand is determined to not be self-occluded, such as if the occlusion is caused by a separate physical object, then the flowchart 200 concludes at block 220, and the input gesture is rejected. Rejecting the input gesture may include, for example, blocking an input action associated with the input gesture from being invoked, cancelling an action associated with the input gesture, or the like.

Returning to block 215, the determination is made that the hand is self-occluded, or if at block 210 a determination is made that the hand is not occluded, then the flowchart optionally proceeds to block 225. Blocks 225-230 show optional steps related to incorporating a debounce period, which provides a parameter to ensure that an occlusion determination is stable for a time period prior to invoking or gating an input action. However, certain criteria may allow the debounce period to be ignored. For example, ignore debounce criteria may include a determination that the input gesture detected at block 205 has followed another active input gesture. At block 225, an optional determination is made as to whether an ignore debounce criterion is satisfied. If a determination is made at block 225 that the ignore debounce criterion is not satisfied, then the flowchart 200 proceeds to optional block 230, where a determination is made as to whether the debounce period is satisfied. As described above, the debounce period may indicate a time period in which an occlusion determination should remain stable prior to allowing an input gesture. Thus, if a determination is made at block 230 that the debounce period is not satisfied, then the flowchart concludes at block 220, and the input gesture is rejected.

Returning to block 225, if an ignore debounce criterion is satisfied, or if the hand is not occluded at block 210, or the hand is self-occluded at block 215 and the optional blocks are skipped, then the flowchart concludes at block 235, and the action associated with the input gesture is allowed. Said another way, the input action associated with the user input gesture detected at block 205 will be invoked. In some embodiments, the action is allowed by providing a gesture signal which can be used to invoke an input action. The input action may be associated with instructions or operations which are triggered upon detection of the input gesture corresponding to the input action, for example by an electronic device. Examples include presentation or removal of user interface components or other virtual content, launching of applications or other operations, selection of selectable user interface components, or the like.

### Sample Hand Tracking Data

As described above, hand occlusion and pose may be determined from hand tracking data. The hand tracking data may be obtained from a hand tracking network, or another source which generates hand tracking data from camera or other sensor data. FIGS. 3A, 3B, and 3C shows diagrams of hand tracking information, in accordance with one or more embodiments. In particular, FIG. 3A shows a hand pose 300A of a hand facing forward. The hand view 302 shows a hand as it may be captured by a camera, such as a camera of an image capture system of an electronic device. According to one or more embodiments, the hand view 302 may be captured from an electronic device from a perspective of the user, such as a head mounted device or other wearable device having an image capture system, or other image capture device positioned such that the hand view can be captured.

According to some embodiments, hand tracking data may be captured for different portions of the hand in order to identify the hand pose or other characteristics of the hand. FIG. 3B shows a diagram of example hand tracking data in the form of a skeleton 305. The skeleton 305 may include a collection of joints tracked by a hand tracking system. In some embodiments, the hand tracking system may determine location information for each joint in the hand. In some embodiments, hand pose 300B may be determined based on geometric characteristics of the skeleton 305.

According to one or more embodiments, the hand tracking system may provide an occlusion score for each joint in the hand. The occlusion score may indicate whether the portion of the hand corresponding to the particular joint (i.e., a portion of the surface of the hand corresponding to the particular joint) is visible from the point of view of the camera. In the example shown, occluded joint 315A is a joint in a palm at the base of the ring finger that is occluded by the upper portion of the ring finger, and is represented by a gray circle. Unoccluded joint 310A represents a joint toward the top of the index finger, which is not occluded, and is represented by a black circle. In some embodiments, the image capture system may include a stereo camera or other multi camera system, in which at least some hand tracking data may be determined for each camera. For example, an occlusion score may be determined for each camera because whether the joint location is occluded will differ based on the camera position of each camera, whereas location information may be determined for each camera, or may be determined based on the combination of image data captured from the cameras. The occlusion score may be a Boolean value indicating whether or not the joint is occluded, or may be a value indicating a confidence value that the joint is occluded, or representing how occluded the joint is, such as when the joint is partially occluded.

In determining whether a hand is occluded by an object, occlusion information for a subset of the joints may be considered. As shown in FIG. 3C, hand pose 300C is shown with a subset of the joints from skeleton 305 from FIG. 3B. In the example shown in FIG. 3C, grip joints 320 are considered in determining whether a hand is self-occluded or occluded by an object. According to one or more embodiments, grip joints 320 may be a collection of hand joints that exclude wrist joints, joints related to the little finger, and metacarpals. Here, the occluded joint 315B and unoccluded joint 310B remain under consideration for a determination as to whether the hand is occluded by a physical object (i.e., an object that is not part of the user's hand), or self-occluded. Notably, because occlusion information can be obtained for each camera capturing the hand, while occluded joint 315B is determined to be occluded in this view, if the hand pose 300C is captured by a stereo camera system, the occluded joint 315B may not be occluded from the perspective of an alternative camera.

### Occlusion Score Determination

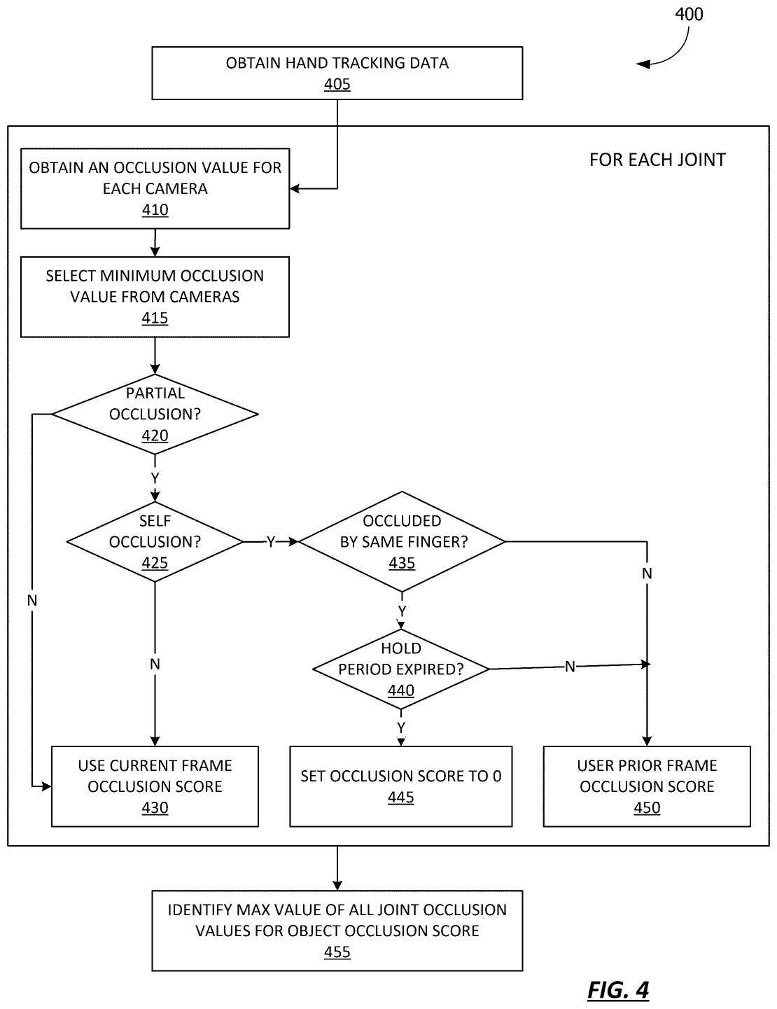

According to one or more embodiments, an object occlusion score is determined for a hand based on a combination of the individual joint occlusion scores and geometric characteristics of the hand pose. FIG. 4 shows a flowchart of a technique for determining an occlusion score, in accordance with some embodiments. For purposes of explanation, the following steps will be described as being performed by particular components. However, it should be understood that the various actions may be performed by alternate components. The various actions may be performed in a different order. Further, some actions may be performed simultaneously, and some may not be required, or others may be added.

The flowchart 400 begins at block 405 where hand tracking data is obtained. According to one or more embodiments, hand tracking data is obtained from one or more camera frames or other frames of sensor data. According to one or more embodiments, the hand tracking data may include image data and/or depth data. The hand tracking data may be obtained from one or more cameras, including stereoscopic cameras or other multi camera image capture systems. In some embodiments, the hand tracking data may include sensor data captured by outward facing cameras of a head mounted device. The hand tracking data may be obtained by applying the sensor data to a hand tracking network or other computing module which generates hand tracking data. According to one or more embodiments, the hand tracking data may include location information for each joint, an occlusion score for each joint, a hand pose based on the configuration of the joint locations, or the like.

The flowchart proceeds to blocks 410-450, which are performed on a per-joint basis based on at least some of the joints for which hand tracking data is available. For example, returning to FIG. 3B, the joints for which blocks 410-450 is applied may be all the joints in skeleton 305 of the hand pose 300B. Alternatively, blocks 410-450 may be applied to a subset of the joints, such as the grip joints 320 of FIG. 3C, or other subsets of joints which are used to determine a hand occlusion score. In some embodiments, performance may be improved by ignoring or discarding some of the joints in determining an overall occlusion score for the hand. Generally, blocks 410-450 present a technique for determining a filtered occlusion value to use for each joint, which are to be used in combination to determine an occlusion score for the hand.

At block 410, an occlusion value is obtained for each camera, for a particular joint. In some embodiments, a particular joint may have different occlusion scores when captured by different cameras simultaneously because of different viewpoints of the camera and/or different hand pose configurations. Accordingly, the occlusion values for a particular joint from different cameras may be the same or may differ.

The flowchart proceeds to block 415, where a minimum occlusion value is selected from the occlusion values obtained at block 410 for a particular joint. Said another way, an occlusion value corresponding to the most visible value from the set of occlusion values is selected. Accordingly, because the determination is performed per joint, an occlusion value for one joint may be selected from a first camera frame captured by the first camera of a multi camera system, whereas an inclusion value for a second joint may be selected from a second camera frame captured by a second camera of a multi-camera system.

The flowchart 400 proceeds to block 420, where a determination is made as to whether the particular joint is at least partially occluded. The joint may be at least partially occluded, for example, if the minimum occlusion value from block 415 is a non-zero value. The determination as to whether the particular joint is at least partially occluded is determined based on the minimum occlusion score selected at block 415. Because the minimum inclusion value corresponds to a most visible view of the joint, the partial occlusion determination 420 only needs to rely on the selected minimum occlusion value.

If at block 420, the particular joint is not at least partially occluded, then the flowchart proceeds to block 430, and the current occlusion score from the minimum occlusion value selected at block 415 is used for the particular joint and determining an overall hand occlusion score. The current occlusion score may be a zero score indicating no occlusion is present, or may be a value below a threshold indicating the joint is likely an occluded.

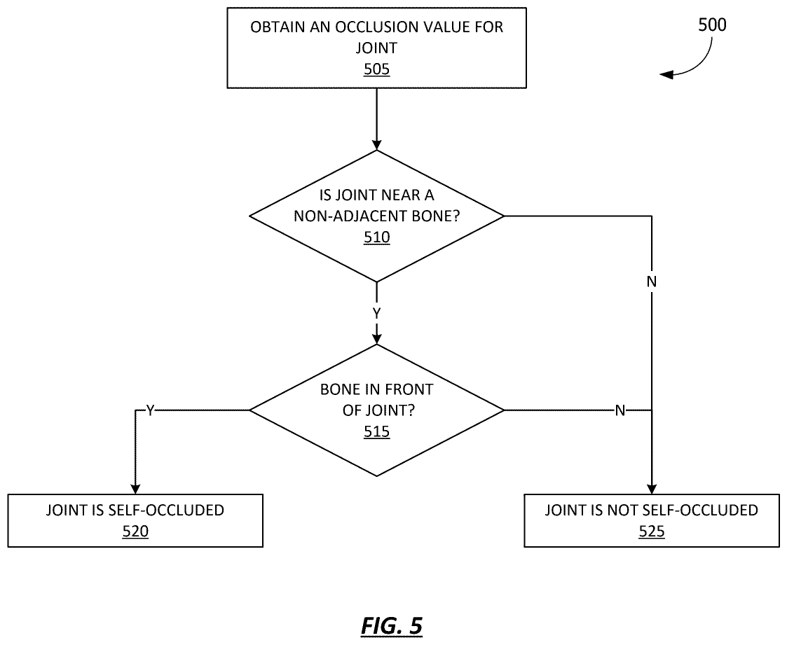

Returning to block 420, if a determination is made that the particular joint is at least partially occluded, then the flowchart proceeds to block 425, and a determination is made as to whether the joint is self-occluded. The joint may be self-occluded if another portion of the hand is causing the occlusion, for example based on relative locations of different portions of the hand. Whether a joint is self-occluded may be determined in a variety of ways, such as using image data, depth data, pose information, and the like. FIG. 5 shows an example technique for determining whether a joint is self-occluded. The flowchart 500 begins at block 505, where an occlusion value is obtained for the joint. The occlusion value may be the minimum occlusion value selected at block 415 of FIG. 4.

The flowchart 500 proceeds to block 510, where a determination is made If the joint is near a non-adjacent bone. As shown in FIG. 3B, a skeleton of the hand may include a collection of joints and bones connecting those joints. Thus, a non-adjacent bone may be a bone that does not terminate at the particular joint. Notably, the various bones and joints determined for purposes of hand tracking may or may not align to biological bones or joints. In some embodiments, location information for the bones may be derived from the location information for the joints being connected by the bone. In some embodiments, a determination is made if the joint is near a non-adjacent bone if the distance between the joint and the closest non-adjacent bone is less than a threshold value. If the joint is determined to not be near a non-adjacent bone, then the flowchart 500 concludes at block 525 and the joint is determined to not be self-occluded.

Returning to block 510, if the determination is made that the joint is near a non-adjacent bone, then the flowchart 500 proceeds to block 515. At block 515, a determination is made as to whether the nearby non-adjacent bone is in front of the particular joint. According to some embodiments, bone location information may be derived from joint location information near the bone provided by hand tracking. In some embodiments, hand tracking may generate the bone information, including bone location information. The determination at block 515 includes determining whether the bone is in front of the particular joint along the camera's line of sight. In some embodiments, determining whether the bone is in front of the joint may include determining whether the bone is at least a threshold distance closer to the camera than the particular joint. Said another way, the bone may have to be at least a threshold distance closer to the camera than the joint, as well as being in front of the joint from the perspective of the camera. If the determination is made that the bone is not in front of the particular joint, then the flowchart concludes at block 525, and the joint is determined to not be self-occluded. Alternatively, returning to block 515, if the bone is determined to be in front of the joint and, optionally, satisfies a threshold distance closer to the camera than the joint, then the flowchart 500 concludes at block 520 and the joint is determined to be self-occluded.

Returning to FIG. 4 at block 425, once the self-occlusion determination is made, if the joint is determined to not be self-occluded, then the current frame occlusion score is used for the joint. However, if at block 425 a determination is made that the joint is self-occluded, then the flowchart 400 proceeds to block 435.

At block 435, a determination is made as to whether the joint is occluded by a portion of the same finger as the joint. This may occur, for example, if the finger is curled such that a top of the finger occludes a lower portion of the finger from the point of view of the camera. In some embodiments, the determination that the joint is occluded by its own finger may be determined based on the location information of the non-adjacent bone that caused the joint to be considered self-occluded. For example, a determination may be made as to whether the bone and the particular joint belong to the same finger. If the determination is made at block 435 that the occlusion is not caused by the same finger to which the particular joint belongs, then the flowchart 400 proceeds to block 450, and an occlusion score from a prior frame is used for the particular joint. Said another way, if the joint is not self-occluded by its own finger, then a prior occlusion value is used for the particular joint. This may occur, for example, if a thumb is bent in such a way as to cause another finger to be occluded from the point of view of the camera. In some embodiments, holding the occlusion score from a prior frame prevents thrash or other unexpected actions if a user's fingers are moving quickly, moving across a physical object being held, or the like.

Returning to block 435, if a determination is made that the particular joint is occluded by the same finger, then the flowchart proceeds to block 440. At block 440, a determination is made as to whether a hold period has expired. In some embodiments, an occlusion value used for particular joint will only be held for a predetermined amount of time to avoid an occlusion state being locked. For example, if a user naturally holds their hands with fingers curled, the occlusion state for the joints may be locked to a particular occlusion score. Thus, if the hold period has not expired, the flowchart 400 proceeds to block 450, and an occlusion score from a prior frame is used for the particular joint. Said another way, if the joint is self-occluded by its own finger, but a hold period has not expired, then a prior occlusion value held for the particular joint. Alternatively, if at block 440, a determination is made that the hold period has expired, then the flowchart 400 proceeds to block 445, and the occlusion score is set to zero. According to one or more embodiments, setting the occlusion score to 0 effectively causes the joint to be ignored in the determination of the overall occlusion score for the joints.

Once steps 415-450 have been performed for each joint or subset of joints in the hand, then the flowchart 400 concludes at block 455, and a max value of all the joint occlusion values determined for the set of joints is identified. Said another way, the scores from blocks 430, 445, and 450 are used in combination to identify a maximum value. The maximum value indicates an object occlusion value for the hand. Said another way, the score determined at block 450 corresponds to occlusion that is the result of a physical object rather than the hand itself.

Once the hand occlusion value is determined, then an input gesture can either be allowed or rejected, as described above with respect to 200. For example, the object occlusion score determined at block 455 of FIG. 4 can be used to determine whether the hand is self-occluded at block 215 of FIG. 2. For example, the object occlusion score from block 455 of FIG. 4 can be compared against a threshold value which indicates whether the hand should be considered to be occluded by an object. Thus, if the threshold value is not satisfied, then the hand may be determined to be self-occluded at block 215 of FIG. 2.

### Suppression of Object Accidentals

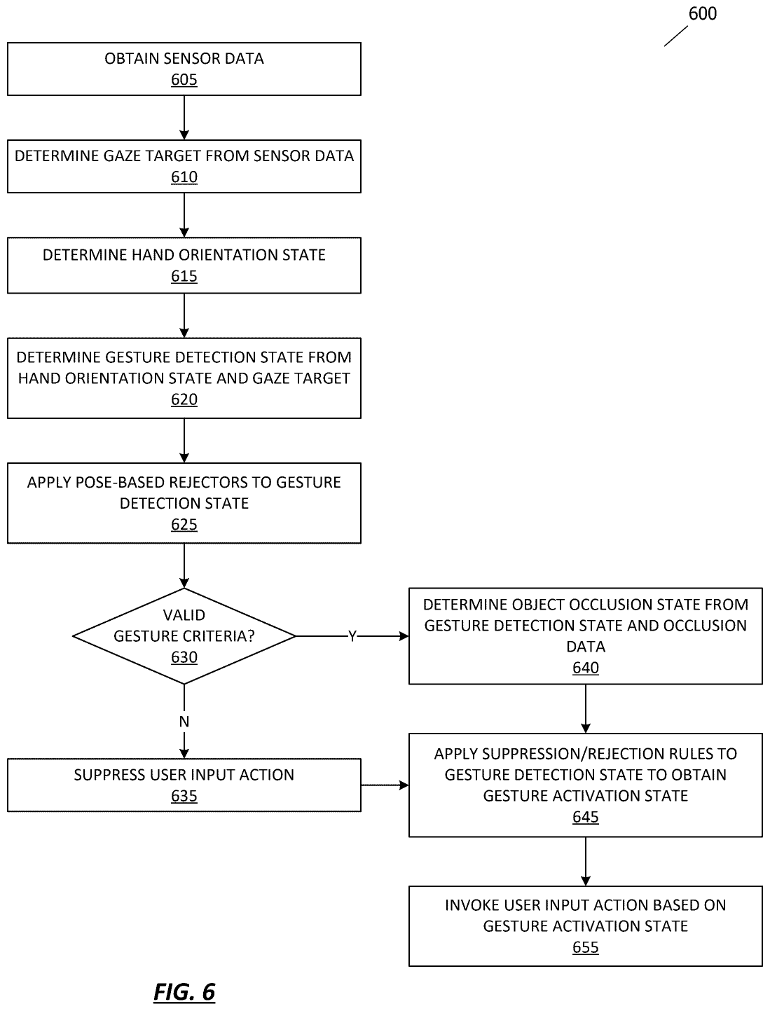

In some embodiments, the process for suppressing object accidentals may be modified by selectively detecting an object occlusion state. Turning to FIG. 6, a flow diagram of a technique for processing user input gestures is presented, in accordance with one or more embodiment. For purposes of explanation, the following steps will be described as being performed by particular components. However, it should be understood that the various actions may be performed by alternate components. The various actions may be performed in a different order. Further, some actions may be performed simultaneously, and some may not be required, or others may be added.

The flowchart begins at block 605, where a device obtains sensor data from one or more cameras and/or other sensors of the electronic device. The sensor data may include, for example, image data, depth data, and the like, from which pose, position, and/or motion can be estimated. For example, location information for one or more joints of a hand can be determined from the sensor data, and used to estimate a pose of the hand. According to one or more embodiments, the sensor data may include position information, orientation information, and or motion information for different portions of the user, including hands, head, eyes, or the like.

In some embodiments, the sensor data may be captured from sensors on an electronic device, such as outward-facing cameras on a head mounted device, or cameras otherwise configured in an electronic device to capture sensor data including a user's hands. In some embodiments, the sensor data may include position and/or orientation information for the electronic device from which location or motion information for the user or a portion of the user, such as the user's head, can be determined. According to some embodiments, a position and/or orientation of the user's head may be derived from the position and/or orientation data of the electronic device when the device is worn on the head, such as with a headset, glasses, or other head-worn device or devices. Inward-facing cameras or other sensors may be used to track eye position and movement from which gaze tracking data can be determined. For example, a head mounted device may include inward-facing sensors configured to capture sensor data of a user's eye or eyes, or regions of the face around the eyes which may be used to determine gaze.

The flowchart 600 proceeds to block 610, where the system determines a gaze target from the sensor data. For example, a direction the user is looking may be determined in the form of a gaze vector. The gaze vector may be projected into a scene that includes physical and virtual content. In doing so a target of the gaze can be determined, which may be a location on a display, a virtual object such as a UI component, a physical object such as a hand, or the like.

At block 615, the system determines a hand orientation state. The hand orientation state may be determined based on an orientation of the hand with respect to predefined poses. According to one or more embodiments, the hand orientation state may indicate a pose and/or position of the hand in a particular frame. In some embodiments, the hand pose may be determined using various metrics of the geometric characteristics of the hand relative to the hand. The gesture detection state may be determined by analyzing the geometric characteristics of the arrangement of joints or regions of the hand, such as the angle, distance, or alignment of the hand or fingers. For example, position and/or orientation information for a palm and a head, and/or relative positioning of the palm and the head may be used to determine whether a palm is mostly facing toward the head or camera, thereby being in a palm-up orientation state, or whether the palm is mostly facing away from the head, thereby being in a palm-down orientation state.

At block 620, the technique determines a gesture detection state from the hand orientation state and the gaze data of the user. According to some embodiments, the gesture detection state may differ from a hand orientation state by using geometric characteristics to infer intentionality of a hand orientation to indicate a gesture. For example, a hand having a hand orientation state of palm up may not be detected as a palm up gesture if other geometric characteristics indicate the hand orientation is not intended to be an input gesture. As an example, hand orientations that correspond to input gestures may be ignored when a user's gaze indicates that the hand orientation is not intended to be an input gesture. In some embodiments, a gaze target may be considered to determine if a gaze criterion is satisfied. A gaze criterion may be satisfied, for example, if a user is looking at the hand performing the pose, or a point in space within a region where virtual content associated with the user input action is currently presented, or where the virtual content would be presented.

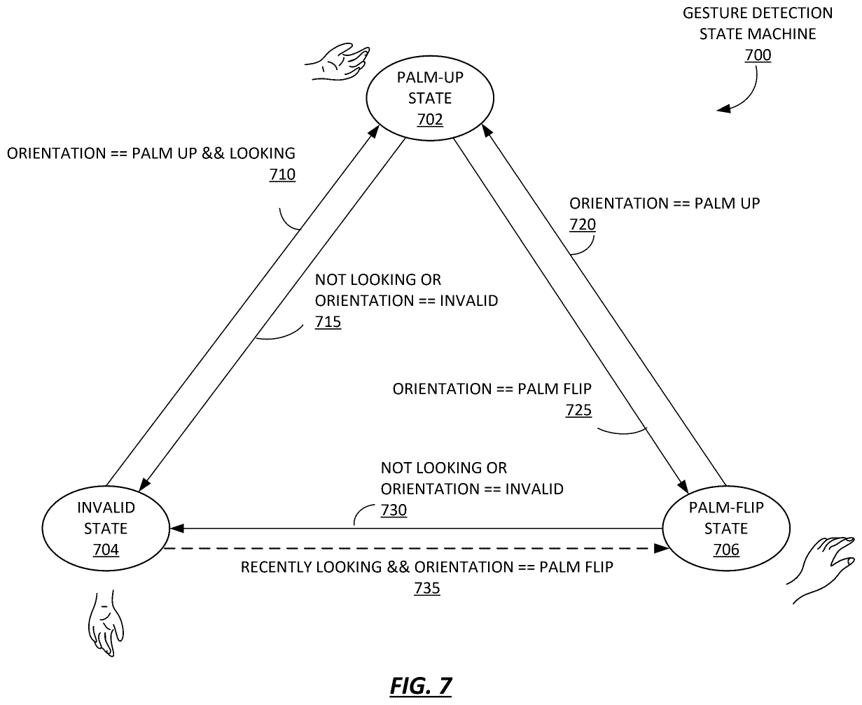

In some embodiments, a gesture detection state machine may be used to determine a gesture detection state. Turning to FIG. 7, a gesture detection state machine for determining a gesture detection state is presented, in accordance with one or more embodiments. As described above, the gaze criterion may be determined to be satisfied if the user is looking at or near a hand or a UI component (or, in some embodiments, a region at which a UI component is to be presented). To that end, the gesture detection state machine 700 indicates that the gaze criterion is satisfied by the term “LOOKING,” and indicates that the gaze criterion is not satisfied by the term “NOT LOOKING,” for purposes of clarity. In some embodiments, the candidate hand gesture states may include a palm-up state 702, a palm-flip state 706, and an invalid state 704, where the gesture is neither in a palm-up state or a palm-flip state. Accordingly, in some embodiments, the gesture detection states may be considered a refined state from the hand orientation state determined based on a geometric position and orientation of the hand, joints of the hand, or the like. Said another way, the gesture detection state may be an extension from the hand orientation state.

According to one or more embodiments, the gesture detection state may transition from a palm-up state 702 to a palm-flip state 706 based on the hand pose determined to be in a palm-flip state, as shown at 725, without respect to gaze. Thus, in some embodiments, the gaze may not be considered in transitioning a gesture from a palm-up state to a palm-flip state. Similarly, at 720, a palm-flip state 706 may transition to a palm-up state 702 based on the hand orientation state being a palm-up state. Said another way, transitions between the palm-up state and palm-flip state may be based on characteristics of the head and hand, such as the palm normal vector, the palm-to-head vector, and/or a head vector, and without regard for a gaze vector. To that end, the gesture detection state may mirror the hand orientation state with respect to transitions between palm-up and palm-flip. In some embodiments, gaze may be considered. For example, gaze may be required to be directed toward the hand or UI component region to determine a state change. If the gaze target moves away from the UI component, then the UI may be dismissed and the UI may need to be re-engaged by looking at the hand.

From a palm-flip state 706, the gesture detection state may transition to an invalid state 704 based on gaze and pose orientation state, as shown at 730. In some embodiments, the gesture detection state may transition from the palm-flip state 706 to an invalid state 704 if a gaze criterion is not satisfied, or if a pose is invalid. Similarly, the gesture detection state may transition from the palm-up state 702 to an invalid state 704 if a gaze criterion is not satisfied, or if a pose is invalid, as shown at 715. Said another way, if the hand orientation state indicated an invalid pose, then the gesture detection state will also be invalid. However, in some embodiments, the hand gesture state may also transition to invalid if, from a palm-flip state 706 or a palm-up state 702, a gaze criterion is not satisfied.

From the invalid state 704, the gesture detection state may transition to the palm-up state 702 if the hand orientation state is a palm-up state, and if the gaze criterion is satisfied, as shown at 710. For example, if from the invalid state, where the hand has been upside down or otherwise pointing downward, a hand orientation state is determined to be in a palm-up state, the gesture detection state will only transition to the palm-up state 702 if the gaze criterion is satisfied.

According to one or more embodiments, the hand gesture state may not support a transition from an invalid state 704 to a palm-flip state 706. However, in some embodiments, the gesture detection state machine 700 may optionally support a transition from invalid state 704 to palm-flip state 706. For example, as shown at 735, the hand gesture state may transition from invalid state 704 to palm-flip state 706 if the hand orientation state is determined to be the palm-flip state, and the gaze is determined to have recently satisfied the gaze criterion. This may occur, for example, if a user glances away and back from a UI component within a predefined window of time.

Returning to FIG. 6, once the gesture detection state is determined, the flowchart 600 proceeds to block 625 where pose-based rejectors are applied to the gesture detection state. According to some embodiments, posed-based rejectors include rejection criteria based on hand pose, from which user input actions are suppressed. In some embodiments, the posed-based rejectors may be based on pose heuristics from the sensor data that are predetermined to be associated with unintentional gestures. That is, the posed-based rejectors include criteria that are predefined to cause a detected gesture to be rejected. Examples of pose-based rejectors include a determination that a pinch gap is not visible, index fingers are curled, or hands are within a threshold distance of each other.

According to one or more embodiments, the pinch gap may not be visible if the hover gap between the thumb tip and index finger bone. Returning to FIG. 3C, the pinch gap 340 is shown as a distance between the thumb tip 330 and the index bone 335 based on the joint locations. The joint locations may be determined as part of determining the hand orientation state, as described above with respect to block 615. If, from the point of view of the cameras, the hover distance between the thumb tip and index bone is not visible, the user may be performing interactions with small or thin objects which may unintentionally appear to be gestures. Examples include gripping small or thin object such as pencils, utensils, small electronic objects, or interacting with small objects such as scrolling on a phone or the like.

The index curl may be detected if the joints of the fingers satisfy a curl threshold such that the index finger is sufficiently curled inside the hand, or if the projected index finer tip is below the knuckle from the view of the cameras. This may occur, for example, if a user is playing a guitar, making a fist, or gripping objects. Thus, if the index curl is detected, the gesture is rejected as being potentially associated with an unintentional gesture.

Hand proximity may be determined based on a distance between the fingertips of one hand to the other hand. This may be determined based on a distance between a fingertip location on one hand and any point of the other hand, for example in world space or camera space. If the distance is less than a threshold, a hand proximity criterion may be satisfied. When two hand are close together, they may be interacting with each other, for example if a user is washing or wringing their hands, eating, holding a phone or other device, or the like.

The various pose rejectors may be applied to the detected gesture to determine whether a valid gesture criteria is satisfied. In some embodiments, if any of the rejectors are detected, then the valid gesture criteria may not be satisfied. Thus, the flowchart proceeds to block 630 and a determination is made as to whether valid gesture criteria is satisfied. If not, the flowchart concludes at block 635, and the user input action for the detected gesture is suppressed. Suppressing the user input action may include, for example, blocking an input action associated with the input gesture from being invoked, cancelling an action associated with the input gesture, or the like. According to one or more embodiments, by applying rejectors at this stage, object occlusion determination can be bypassed when it is unnecessary, thereby improving latency of input gesture actions.

Returning to block 630, if a determination is made that the valid gesture criteria is satisfied, then the flowchart proceeds to block 640, and an object occlusion state is determined from the gesture detection state of block 620, and occlusion data. The object occlusion state may indicate whether the hand or a portion of the hand is occluded by a physical object, such as an object being held by the hand, or by the hand itself, such as when the fingers are curled or crossed. According to some embodiments, determining the object occlusion state may include determining an object detection state, as well as a signal confidence. Because occlusion is dependent on hand pose and/or orientation, objects, environment, and the like, whether occlusion is caused by self-occlusion, or occlusion by an object can be ambiguous. Thus, an object occlusion state may be classified as visible (i.e., unoccluded), occluded, or ambiguous.

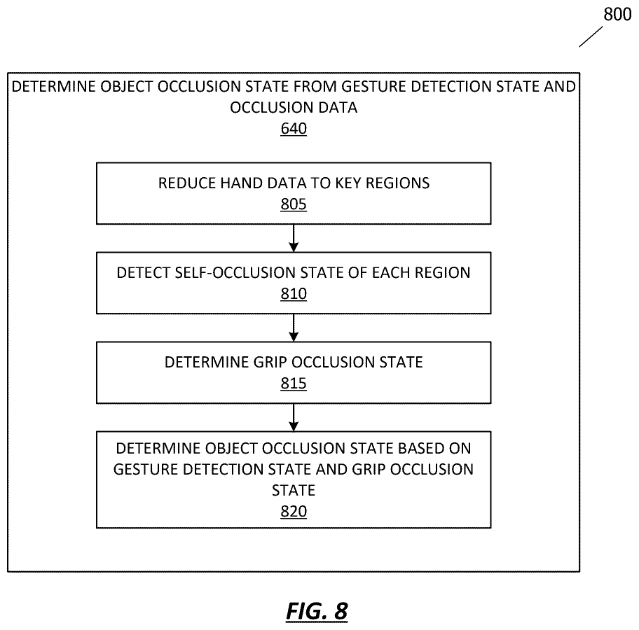

Turning to FIG. 8, an example technique for determining an object occlusion state is presented. The object occlusion state may indicate whether the hand or a portion of the hand is occluded by a physical object, such as an object being held by the hand, or by the hand itself, such as when the fingers are curled or crossed. The object occlusion state may be determined by analyzing the occlusion scores and the reliability of the self-occlusion state for each region of the hand.

The flowchart 800 begins at block 805, where the system reduces the hand data to key regions. The hand data may include hand tracking data, such as hand pose, joint locations and the like, and the occlusion data obtained from the sensor data. The hand data may include location information and occlusion scores for each joint or region of the hand, and a hand pose based on the configuration of the joint locations. The technique reduces the hand data to key regions by selecting a subset of the joints or regions of the hand that are relevant or reliable for determining the object occlusion state. According to one or more embodiments, the key regions may include regions that are common with gripping objects and less susceptible to self-occlusion noise. In some embodiments, the key regions may include the grip regions, as described above with respect to FIG. 3C. According to one or more embodiments, grip regions may be a collection of hand joints that exclude wrist joints, joints related to the little finger, and metacarpals. In some embodiments, the grip regions may me limited to index finger joints, index finger and secondary knuckles. In other embodiments, the key regions may include additional or alternative joints or regions that are a subset of the hand joints.

The flowchart 800 proceeds to block 810, where a self-occlusion state is detected for each region. The self-occlusion state of each region may be determined by analyzing the occlusion scores for each joint or region of the hand, which may indicate whether the portion of the hand corresponding to the joint or region is visible from the point of view of the camera or other sensors. The object occlusion state may also be determined by analyzing the relative locations of the joints or regions of the hand, which may indicate whether the portion of the hand is in front of or behind another portion of the hand or a non-adjacent bone. An example technique for determining object occlusion scores for each joint or region of the hand is described above with respect to FIGS. 4-5.

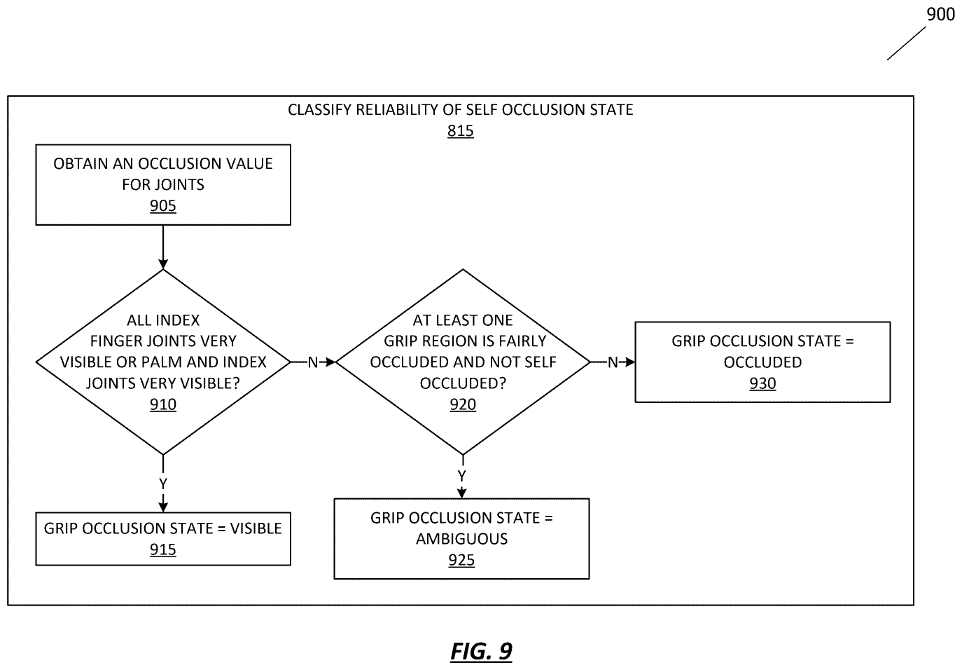

At block 815, a reliability of the self-occlusion state is determined. The reliability of the self-occlusion state may be performed on a per-frame basis. The reliability determination may be based on a grip occlusion state, which may consider occlusion signals of non-self-occluded regions to determine an object occlusion state. FIG. 9 is a flowchart of an example technique for classifying the reliability of the self-occlusion state for a grip region of the hand, in accordance with some embodiments.

The flowchart 900 begins at block 905, where an occlusion values for the joints of grip region of the hand are obtained. The occlusion values may be a Boolean value indicating a level of occlusion for the joint, or how likely it is that the joint is occluded. The occlusion values may be obtained from a hand tracking pipeline, and/or as described above with respect to FIG. 4.

The flowchart 900 proceeds to block 910, where a determination is made as to whether all index finger joints are very visible, or whether the palm and index joints are very visible. For example, a determination may be made as to whether all index finger joints have an occlusion value that satisfies an index finger visibility threshold, or otherwise satisfies an index finger visibility criterion. The occlusion values for the palm (i.e., knuckle joints) and index joints, except for the index knuckle, may be compared to a palm and index visibility threshold, or otherwise compared against a palm and index visibility criterion, which may be the same or different than the index finger visibility criterion. If either are satisfied, then the flowchart 900 proceeds to block 915 and the grip occlusion state is determined to be visible. The visible category may indicate that the self-occlusion state is reliable and that the grip region is not occluded by another region of the hand or a non-adjacent bone of the hand.

Returning to block 910, if a determination is made that the index finger joints are not determined to be very visible, and the palm and index joints are also determined to be not very visible, then the flowchart 900 proceeds to block 920. At block 920, a determination is made as to whether at least one grip region is fairly occluded and not self-occluded. According to one or more embodiments, the reduced joints may be grouped into grip regions, such as index joints, index knuckle, and secondary knuckles. In some embodiments, an occlusion for each grip region may be based on the occlusion values for the joints that each of the grip regions may be determined as described above, for example with respect to FIGS. 4-5. For example, as described with respect to FIG. 4, an occlusion value for a grip region may be a maximum value of all joint occlusion values for each of the joints in the grip region.

In some embodiments, determining the self-occlusion of each grip region may include computing a minimum distance to all occluding bone segments, where the bone segment is closer to the camera. In some embodiments, the minimum distance may be binarized to compare the distance against a threshold distance to determine whether the grip region is self-occluded. For example, a minimum distance of less than 2.5 cm may be used to determine that the grip is self-occluded. In some embodiments, a different threshold may be used to determine whether the grip region is no longer self-occluded, such as a break threshold. For example, a grip region may enter the self-occluded state when the minimum distance is less than 2.5 cm, and may maintain a self-occluded state until the minimum distance is greater than a different threshold, such as 3 cm.

If at least one of the grip regions is determined to be fairly occluded, such as an occlusion value satisfying a grip occlusion threshold, and is determined to not be self-occluded, then the flowchart 900 concludes at block 925, and the grip occlusion state is determined to be ambiguous. The ambiguous category may indicate that the self-occlusion state is unreliable or uncertain and that the grip region may or may not be occluded by another region of the hand or a non-adjacent bone of the hand. By contrast, if at block 920, a grip region exists that is either determined to not satisfy the grip occlusion threshold, or is determined to be self-occluded, the flowchart 900 concludes at block 930, and the grip occlusion state is determined to be occluded.

Returning to FIG. 8, once the reliability of the self-occlusion state is determined, the flowchart proceeds to block 820 and an object occlusion state is determined based on a current hand gesture and grip occlusion state. In some embodiments, object occlusion detection is made more robust for ambiguous states by considering that it is difficult to add or remove a gripped object with one hand in a palm up orientation.

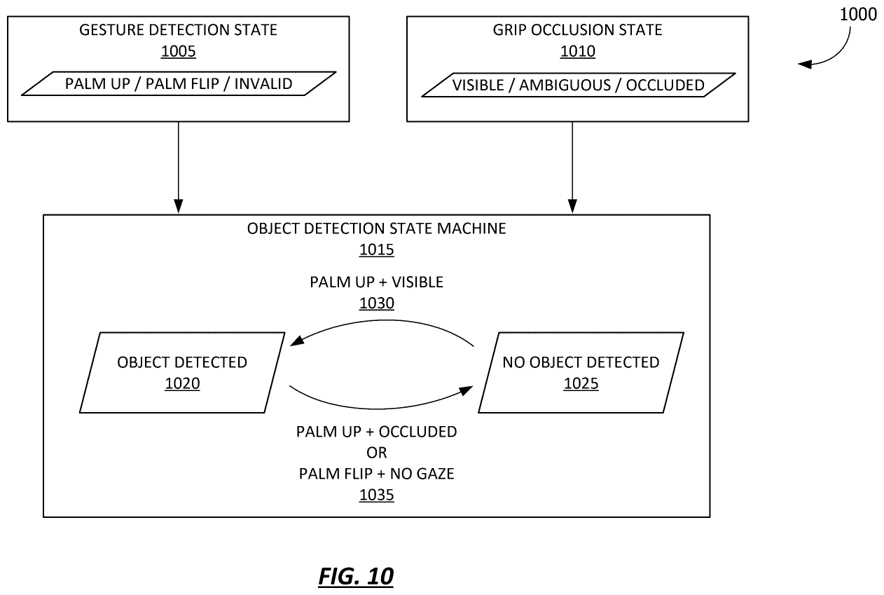

FIG. 10 shows an example technique for determining the object occlusion state. In particular, FIG. 10 is a diagram of an object detection state machine 1015, in accordance with some embodiments. The object detection state machine may use, as inputs, a gesture detection state 1005, and a grip occlusion state 1010. According to one or more embodiments, the gesture detection state may include a classification of palm up, palm flip, or invalid. The gesture detection state may be determined, for example, as described above with respect to FIG. 7. The grip occlusion state may include a classification of visible, ambiguous, or occluded. The grip occlusion state may be determined, for example, as described above with respect to FIG. 9.

The object detection state machine 1015 may determine whether a current object detection state is object detected 1020, or no object detected 1025. The object detected state 1025 may indicate that the hand or a portion of the hand is likely occluded by a physical object, such as when the user is holding an object or interacting with an object in the physical environment. The object detected state 1025 may be entered from the no object detected state 1020 when the gesture detection state is palm up, and the grip occlusion state is visible, as shown at 1030. The object detection state may transition from the object detected state 1020 to the no object detected state 1025 when the gesture detection state is palm up and the grip occlusion state is occluded, or if the gesture detection state is palm flip and no gaze is detected, as shown at 1035.

According to one or more embodiments, if a hand was in a palm up state with a visible grip occlusion state, and becomes ambiguous, there is probably not an object. If a hand was in an object occluded state with the palm up, and the sate becomes ambiguous, here is probably still an object. If the hand entered a palm up gesture detection state while in an ambiguous grip occlusion state, robustness is improved by assuming an object is still detected until proven otherwise. In some embodiments, a location may be cached representing where an object would be located in the hand, and if the hand is in an idle palm flip and moves away, the state machine may transition to no object detected 1025.

Returning to FIG. 6, the object occlusion state may be used at block 645 to apply suppression/rejection rules to the gesture detection state to obtain a gesture activation state. The gesture activation state may indicate whether the input gesture is valid and intentional, and whether it should trigger a user input action, such as invoking or dismissing a user interface or other virtual content. An object detected state determined at block 640 may be used as a rejector, in accordance with one or more embodiments. Further, a user input action suppression from block 635 may be used as a suppressor.

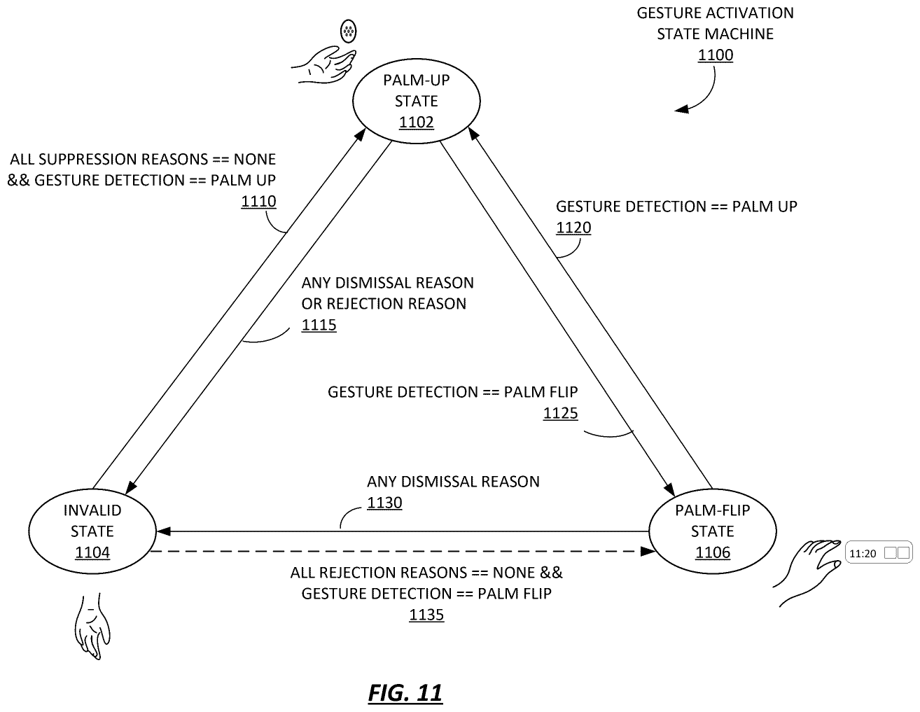

FIG. 11 shows a state machine for activation and suppression of hand gestures, in accordance with one or more embodiments. In some embodiments, the candidate gesture activation states may include a palm-up state 1102, a palm-flip state 1106, and an invalid state 1104, where the gesture is neither in a palm-up state or a palm-flip state. The gesture activation state is used to determine whether to activate a user input action associated with a hand gesture. Thus, the gesture activation state is used to activate user input actions associated with the corresponding state. Accordingly, in some embodiments, the gesture activation state machine 1100 may begin from a state determined from the gesture detection state machine 700 of FIG. 7.

According to one or more embodiments, the gesture activation state may transition from a palm-up state 1102 to a palm-flip state 1106 based on the gesture detection state determined to be in a palm-flip state, as shown at 1125. Thus, in some embodiments, the rejection and suppression criteria may not be considered in transitioning from a palm-up state to a palm-flip state. Similarly, at 1120, a palm-flip state 1106 may transition to a palm-up state 1102 based on the gesture activation state being a palm-up state. Said another way, transitions between the palm-up state and palm-flip state may be based on characteristics of the head and hand, without regard for suppression and/or rejection criteria (or, as described above with respect to gesture detection state machine 700 of FIG. 7, gaze information). Further, the transitions between palm up and palm flip may be based on the determined hand orientation state.

From a palm-flip state 1106, the gesture activation state may transition to an invalid state 1104 based on gaze and hand pose information, as shown at 1130. In some embodiments, the hand gesture state may transition from the palm-flip state 1106 to an invalid state 1104 if any suppression or rejection reason is true, such as the detection of an object occlusion, as described above with respect to block 640, or an invalid gesture, as described above with respect to block 635. Similarly, the gesture activation state may transition from the palm-up state 1102 to an invalid state 1104 if any rejector or suppression reason is true, as shown at 1115.

From the invalid state 1104, the gesture activation state may transition to the palm-up state 1102 if the gesture detection state is a palm-up state and if no suppression reasons are true, as shown at 1110. For example, if from the invalid state 1104, where the hand has been upside down or otherwise pointing downward, a gesture detection state is determined to be in a palm-up state, the hand gesture state will only transition to the palm-up state 1102 (as a gesture activation state) if there is no suppression or rejection criteria.

According to one or more embodiments, the gesture activation state machine 1100 may not support a transition from an invalid state 1104 to a palm-flip state 1106. However, in some embodiments, the gesture activation state machine 1100 may optionally support a transition from invalid state 1104 to palm-flip state 1106. For example, as shown at 1135, the gesture activation state may transition from invalid state 1104 to palm-flip state 1106 if the hand gesture state is determined to be the palm-flip state, and no rejection reasons are true.

Returning to FIG. 6, the flowchart 600 concludes at block 655, where a user input action may be invoked in accordance with the gesture activity state. For example, if the gesture activation state is a palm up or a palm flip, an associated user input component may be activated. The palm up may be associated with a first user input component, whereas the palm flip may be associated with a second user input component. However, if the gesture activation state is invalid, then no user input action may be invoked.

### Example Electronic Device and Related Components

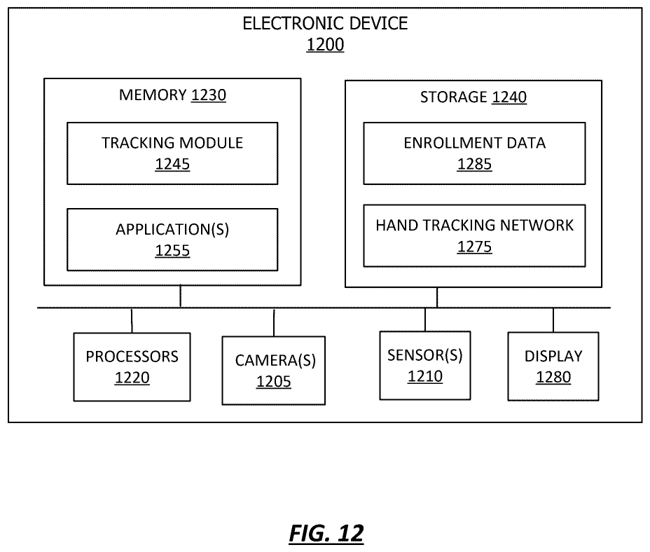

Referring to FIG. 12, a simplified block diagram of an electronic device 1200 is depicted. Electronic device 1200 may be part of a multifunctional device, such as a mobile phone, tablet computer, personal digital assistant, portable music/video player, wearable device, head-mounted systems, projection-based systems, base station, laptop computer, desktop computer, network device, or any other electronic systems such as those described herein. Electronic device 1200 may include one or more additional devices within which the various functionality may be contained or across which the various functionality may be distributed, such as server devices, base stations, accessory devices, etc. Illustrative networks include, but are not limited to, a local network such as a universal serial bus (USB) network, an organization's local area network, and a wide area network such as the Internet. According to one or more embodiments, electronic device 1200 is utilized to interact with a user interface of an application 1255. It should be understood that the various components and functionality within electronic device 1200 may be differently distributed across the modules or components, or even across additional devices.

Electronic Device 1200 may include one or more processors 1220, such as a central processing unit (CPU) or graphics processing unit (GPU). Electronic device 1200 may also include a memory 1230. Memory 1230 may include one or more different types of memory, which may be used for performing device functions in conjunction with processor(s) 1220. For example, memory 1230 may include cache, ROM, RAM, or any kind of transitory or non-transitory computer-readable storage medium capable of storing computer-readable code. Memory 1230 may store various programming modules for execution by processor(s) 1220, including tracking module 1245, and other various applications 1255. Electronic device 1200 may also include storage 1240. Storage 1240 may include one more non-transitory computer-readable mediums including, for example, magnetic disks (fixed, floppy, and removable) and tape, optical media such as CD-ROMs and digital video disks (DVDs), and semiconductor memory devices such as Electrically Programmable Read-Only Memory (EPROM) and Electrically Erasable Programmable Read-Only Memory (EEPROM). Storage 1230 may be utilized to store various data and structures which may be utilized for storing data related to hand tracking and UI preferences. Storage 1240 may be configured to store hand tracking network 1275 according to one or more embodiments. Storage 1240 may additionally include enrollment data 1285, which may be used for personalized hand tracking. For example, enrollment data may include physiological characteristics of a user such as hand size, bone length, and the like. Electronic device may additionally include a network interface from which the electronic device 1200 can communicate across a network.

Electronic device 1200 may also include one or more cameras 1205 or other sensors 1210, such as a depth sensor, from which depth of a scene may be determined. In one or more embodiments, each of the one or more cameras 1205 may be a traditional RGB camera or a depth camera. Further, cameras 1205 may include a stereo camera or other multicamera system. In addition, electronic device 1200 may include other sensors which may collect sensor data for tracking user movements, such as a depth camera, infrared sensors, or orientation sensors, such as one or more gyroscopes, accelerometers, and the like.

According to one or more embodiments, memory 1230 may include one or more modules that comprise computer-readable code executable by the processor(s) 1220 to perform functions. Memory 1230 may include, for example, tracking module 1245, and one or more application(s) 1255. Tracking module 1245 may be used to track locations of hands and other user motion in a physical environment. Tracking module 1245 may use sensor data, such as data from cameras 1205 and/or sensors 1210. In some embodiments, tracking module 1245 may track user movements to determine whether to trigger user input from a detected input gesture. In doing so, tracking module 1245 may be used to determine occlusion information for the hand. Electronic device 1200 may also include a display 1280 which may present a UI for interaction by a user. The UI may be associated with one or more of the application(s) 1255, for example. Display 1280 may be an opaque display or may be semitransparent or transparent. Display 1280 may incorporate LEDs, OLEDs, a digital light projector, liquid crystal on silicon, or the like.

Although electronic device 1200 is depicted as comprising the numerous components described above, in one or more embodiments, the various components may be distributed across multiple devices. Accordingly, although certain calls and transmissions are described herein with respect to the particular systems as depicted, in one or more embodiments, the various calls and transmissions may be made differently, or may be differently directed based on the differently distributed functionality. Further, additional components may be used, some combination of the functionality of any of the components may be combined.

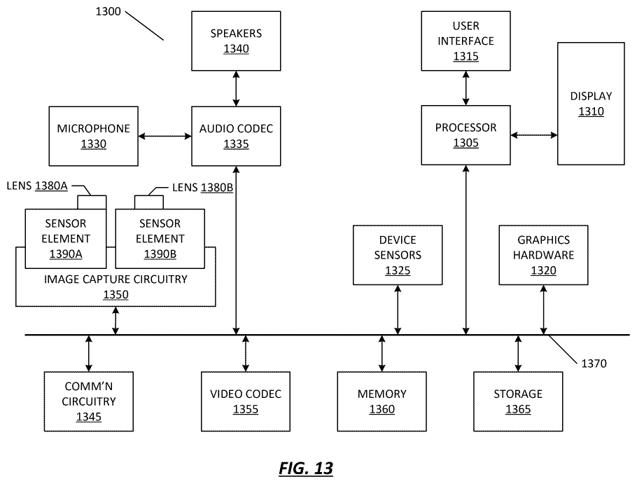

Referring now to FIG. 13, a simplified functional block diagram of illustrative multifunction electronic device 1300 is shown according to one embodiment. Each of electronic devices may be a multifunctional electronic device or may have some or all of the described components of a multifunctional electronic device described herein. Multifunction electronic device 1300 may include processor 1305, display 1310, user interface 1315, graphics hardware 1320, device sensors 1325 (e.g., proximity sensor/ambient light sensor, accelerometer and/or gyroscope), microphone 1330, audio codec(s) 1335, speaker(s) 1340, communications circuitry 1345, digital image capture circuitry 1350 (e.g., including camera system), video codec(s) 1355 (e.g., in support of digital image capture unit), memory 1360, storage device 1365, and communications bus 1370. Multifunction electronic device 1300 may be, for example, a digital camera or a personal electronic device such as a personal digital assistant (PDA), personal music player, mobile telephone, or a tablet computer.

Processor 1305 may execute instructions necessary to carry out or control the operation of many functions performed by device 1300 (e.g., such as the generation and/or processing of images as disclosed herein). Processor 1305 may, for instance, drive display 1310 and receive user input from user interface 1315. User interface 1315 may allow a user to interact with device 1300. For example, user interface 1315 can take a variety of forms, such as a button, keypad, dial, a click wheel, keyboard, display screen, touch screen, gaze, and/or gestures. Processor 1305 may also, for example, be a system-on-chip such as those found in mobile devices and include a dedicated GPU. Processor 1305 may be based on reduced instruction-set computer (RISC) or complex instruction-set computer (CISC) architectures or any other suitable architecture and may include one or more processing cores. Graphics hardware 1320 may be special purpose computational hardware for processing graphics and/or assisting processor 1305 to process graphics information. In one embodiment, graphics hardware 1320 may include a programmable GPU.

Image capture circuitry 1350 may include two (or more) lens assemblies 1380A and 1380B, where each lens assembly may have a separate focal length. For example, lens assembly 1380A may have a short focal length relative to the focal length of lens assembly 1380B. Each lens assembly may have a separate associated sensor element 1390A and 1390B. Alternatively, two or more lens assemblies may share a common sensor element. Image capture circuitry 1350 may capture still and/or video images. Output from image capture circuitry 1350 may be processed by video codec(s) 1355 and/or processor 1305 and/or graphics hardware 1320, and/or a dedicated image processing unit or pipeline incorporated within circuitry 1365. Images so captured may be stored in memory 1360 and/or storage 1365.

Sensor and camera circuitry 1350 may capture still, and video images that may be processed in accordance with this disclosure, at least in part, by video codec(s) 1355 and/or processor 1305 and/or graphics hardware 1320, and/or a dedicated image processing unit incorporated within circuitry 1350. Images so captured may be stored in memory 1360 and/or storage 1365. Memory 1360 may include one or more different types of media used by processor 1305 and graphics hardware 1320 to perform device functions. For example, memory 1360 may include memory cache, read-only memory (ROM), and/or random-access memory (RAM). Storage 1365 may store media (e.g., audio, image, and video files), computer program instructions or software, preference information, device profile information, and any other suitable data. Storage 1365 may include one more non-transitory computer-readable storage mediums including, for example, magnetic disks (fixed, floppy, and removable) and tape, optical media such as CD-ROMs and DVDs, and semiconductor memory devices such as EPROM and EEPROM. Memory 1360 and storage 1365 may be used to tangibly retain computer program instructions, or code organized into one or more modules and written in any desired computer programming language. When executed by, for example, processor 1305 such computer program code may implement one or more of the methods described herein.

Various processes defined herein consider the option of obtaining and utilizing a user's identifying information. For example, such personal information may be utilized in order to track a user's pose and/or motion. However, to the extent such personal information is collected, such information should be obtained with the user's informed consent, and the user should have knowledge of and control over the use of their personal information.

Personal information will be utilized by appropriate parties only for legitimate and reasonable purposes. Those parties utilizing such information will adhere to privacy policies and practices that are at least in accordance with appropriate laws and regulations. In addition, such policies are to be well established and in compliance with or above governmental/industry standards. Moreover, these parties will not distribute, sell, or otherwise share such information outside of any reasonable and legitimate purposes.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing specific identifiers (e.g., date of birth), controlling the amount or specificity of data stored (e.g., collecting location data at city level rather than at an address level), controlling how data is stored (e.g., aggregating data across users), and/or other methods.

It is to be understood that the above description is intended to be illustrative and not restrictive. The material has been presented to enable any person skilled in the art to make and use the disclosed subject matter as claimed and is provided in the context of particular embodiments, variations of which will be readily apparent to those skilled in the art (e.g., some of the disclosed embodiments may be used in combination with each other). Accordingly, the specific arrangement of steps or actions shown in FIGS. 1A-B, 3A-3C, and 12-13 or the arrangement of elements shown in FIGS. 2 and 4-11 should not be construed as limiting the scope of the disclosed subject matter. The scope of the invention therefore should be determined with reference to the appended claims, along with the full scope of equivalents to which such claims are entitled. In the appended claims, the terms “Including” and “in which” are used as the plain-English equivalents of the respective terms “comprising” and “wherein.”

1. A method comprising:
obtaining hand tracking data from one or more cameras of a hand in a pose corresponding to an input gesture; and
in response to a determination that at least part of the hand is occluded:
determining, based on the hand tracking data, whether the hand is self-occluded, and
in response to a determination that the hand is self-occluded, providing a gesture signal for the input gesture to invoke an action corresponding to the input gesture.

2. The method of claim 1, further comprising:
obtaining additional hand tracking data from the one or more cameras;
in response to a determination that at least part of the hand is occluded based on the additional hand tracking data:
determining, based on the additional hand tracking data, that the hand is occluded by a physical object; and
in response to determining that the hand is occluded by the physical object, rejecting the input gesture.

3. The method of claim 1, wherein determining whether the hand is self-occluded comprises:
obtaining occlusion scores for each of a plurality of portions of the hand; and
determining, based on relative locations of the plurality of portions of the hand, whether the hand is self-occluded.

4. The method of claim 3, wherein determining whether the hand is self-occluded comprises:
obtaining an occlusion value for a first portion of the hand; and
determining whether a second portion of the hand is in front of the first portion of the hand.

5. The method of claim 3, wherein the determination whether the hand is self-occluded is performed in response to a determination that a valid gesture criteria is satisfied based on the hand tracking data.

6. The method of claim 3, further comprising:
determining a grip occlusion state based on the occlusion scores; and
determining an object occlusion state based on the grip occlusion state and the input gesture,
wherein the gesture signal is provided for the input gesture based on the object occlusion state.

7. The method of claim 3, wherein determining whether the hand is self-occluded comprises:
obtaining a maximum occlusion score among the occlusion scores for the plurality of portions of the hand.

8. A non-transitory computer readable medium comprising computer readable code executable by one or more processors to:
obtain hand tracking data from one or more cameras of a hand in a pose corresponding to an input gesture; and
in response to a determination that at least part of the hand is occluded:
determine, based on the hand tracking data, whether the hand is self-occluded, and
in response to a determination that the hand is self-occluded, provide a gesture signal for the input gesture to invoke an action corresponding to the input gesture.

9. The non-transitory computer readable medium of claim 8, further comprising computer readable code to:
obtain additional hand tracking data from the one or more cameras;
in response to a determination that at least part of the hand is occluded based on the additional hand tracking data:
determine, based on the additional hand tracking data, that the hand is occluded by a physical object; and
in response to determining that the hand is occluded by the physical object, reject the input gesture.

10. The non-transitory computer readable medium of claim 8, wherein the computer readable code to determine whether the hand is self-occluded comprises computer readable code to:
obtain occlusion scores for each of a plurality of portions of the hand; and
determine, based on relative locations of the plurality of portions of the hand, whether the hand is self-occluded.

11. The non-transitory computer readable medium of claim 10, wherein the computer readable code to determine whether the hand is self-occluded comprises computer readable code to:
obtain an occlusion value for a first portion of the hand; and
determine whether a second portion of the hand is in front of the first portion of the hand.

12. The non-transitory computer readable medium of claim 10, wherein the determination whether the hand is self-occluded is performed in response to a determination that a valid gesture criteria is satisfied based on the hand tracking data.

13. The non-transitory computer readable medium of claim 10, further comprising computer readable code to:
determine a grip occlusion state based on the occlusion scores; and
determine an object occlusion state based on the grip occlusion state and the input gesture,
wherein the gesture signal is provided for the input gesture based on the object occlusion state.

14. The non-transitory computer readable medium of claim 10, wherein the computer readable code to determine whether the hand is self-occluded comprises computer readable code to:
obtain a maximum occlusion score among the occlusion scores for the plurality of portions of the hand.

15. A system comprising:
one or more processors; and
one or more computer readable medium comprising computer readable code executable by the one or more processors to:
obtain hand tracking data from one or more cameras of a hand in a pose corresponding to an input gesture;
in response to a determination that at least part of the hand is occluded:
determine, based on the hand tracking data, whether the hand is self-occluded; and
in response to a determination that the hand is self-occluded, provide a gesture signal for the input gesture to invoke an action corresponding to the input gesture.

16. The system of claim 15, further comprising computer readable code to:
obtain additional hand tracking data from the one or more cameras;
in response to a determination that at least part of the hand is occluded based on the additional hand tracking data:
determine, based on the additional hand tracking data, that the hand is occluded by a physical object; and
in response to determining that the hand is occluded by the physical object, reject the input gesture.

17. The system of claim 15, wherein the computer readable code to determine whether the hand is self-occluded comprises computer readable code to:
obtain occlusion scores for each of a plurality of portions of the hand; and
determine, based on relative locations of the plurality of portions of the hand, whether the hand is self-occluded.

18. The system of claim 17, wherein the computer readable code to determine whether the hand is self-occluded comprises computer readable code to:
obtain an occlusion value for a first portion of the hand; and
determine whether a second portion of the hand is in front of the first portion of the hand.

19. The system of claim 17, wherein the determination whether the hand is self-occluded is performed in response to a determination that a valid gesture criteria is satisfied based on the hand tracking data.

20. The system of claim 17, further comprising computer readable code to:
determine a grip occlusion state based on the occlusion scores; and
determine an object occlusion state based on the grip occlusion state and the input gesture,
wherein the gesture signal is provided for the input gesture based on the object occlusion state.
